(19) United States
(12) Patent Application Publication
(10) Pub. No.: US 2002/0158533 A1
(43) Pub. Date: Oct. 31, 2002

(54) Method and apparatus for single press resilient rotor mounting assembly

(76) Inventor: Kamron M. Wright, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,550

(22) Filed: Apr. 27, 2001

(51) Int. Cl. H02K 15/02; H02K 5/00

(52) U.S. Cl. 310/156.08; 29/598

(57) ABSTRACT

A rotor mounting assembly includes a first resilient ring, a second resilient ring and a spacer. The resilient rings and the spacer are fabricated from center punch laminates produced from a stator bore punch process. The second resilient ring includes at least one aperture in addition to a central bore. A method of fabricating the rotor mounting assembly includes positioning a press pin through the aperture to contact the first resilient ring which allows a press to simultaneously presses both resilient rings onto a knurled rotor shaft, reducing manufacturing cost.

### BACKGROUND OF THE INVENTION

This invention relates generally to electric motors and, more particularly, to methods and apparatus for reducing vibration in a rotor core assembly for electric motors.

Electric motors are used in many applications worldwide. Typically, the rotational force and torque generated within the motor is delivered by a rotor shaft. The torque generated is the product of current applied to the motor and an electromagnetic field maintained about stator. When a rotor-generated magnetic field enters a stator-generated magnetic field the rotor tends to speed up and when the rotor magnetic field leaves the stator magnetic field the rotor tends to slow down. The torque produced is therefore non-uniform and known to those in the art as torque ripple or cogging. Torque ripple, and various machine imperfections, may generate objectionable noise and vibration at the motor shaft in some applications.

One example of such an application occurs when a motor drives a fan. Imbalances in the fan, combined with torque ripple, generate vibrations which are transmitted to the motor and fan mounting. These vibrations generate undesirable noise. Continued exposure over time to such vibrations loosens motor and fan assemblies, and ultimately could cause failure of the motor. Damping systems are typically employed to minimize the effects of the vibrational energy induced into the motor and fan system.

### SUMMARY OF INVENTION

In an exemplary embodiment, a resilient rotor mounting assembly facilitating a simplified assembly with fewer press operations includes a first resilient ring, a second resilient ring and a substantially tubular spacer. The resilient rings and the spacer are fabricated from center punch laminates generated from a stator laminate bore punch process. The resilient rings attach to opposite ends of the spacer. The resilient rings each include a central bore with a diameter to receive the rotor shaft. The diameter of the first resilient ring central bore is larger than the diameter of the second resilient ring central bore. The rotor shaft includes a first knurled portion and a second knurled portion, each sized to fit the bore diameter of one of the resilient rings. The first knurled portion has a larger diameter and is distal from a press used in the press operations. In the exemplary embodiment the second resilient ring includes two apertures in addition to the central bore.

A method of constructing the resilient mounting assembly includes fabricating the resilient rings and the spacer from center blank laminates produced from a stator laminate bore punch process. The resilient rings include a resilient insert. An operator attaches the resilient rings to the spacer and inserts the rotor shaft in the resilient mounting assembly. The first resilient ring passes over the second knurled portion. The operator inserts a press pin through the aperture in the second resilient ring and into contact with the first resilient ring. A press pin shoulder is also positioned against the second resilient ring. The press simultaneously presses both resilient rings onto the rotor shaft knurled portions in one operation, reducing manufacturing cost.

During operation, non-uniform magnetic fields of the motor generate torque ripple in the rotor core. The resilient inserts of the rotor mounting assembly damp vibrations generated as a result of such torque ripple. Reductions in torque ripple reduce vibrations and noise of the motor. As a result, more complex and expensive damping systems may be eliminated.

### BRIEF DESCRIPTION OF DRAWINGS

FIG. 1 is an exploded perspective view of a motor.

FIG. 2 is an enlarged top view of a punched laminate element.

FIG. 3 is side view of an exemplary embodiment of a rotor shaft.

FIG. 4 is cross-sectional view of an exemplary embodiment of a laminated rotor mounting assembly.

FIG. 5 is a side view of a first resilient ring of the laminated rotor mounting assembly of FIG. 4.

FIG. 6 is a side view of a second resilient ring of the laminated rotor mounting assembly of FIG. 4.

FIG. 7 is a cross-sectional view of an inner metal insert of the rotor mounting assembly of FIG. 6.

FIG. 8 is an enlarged cross-sectional view of an alternative inner metal insert.

### DETAILED DESCRIPTION

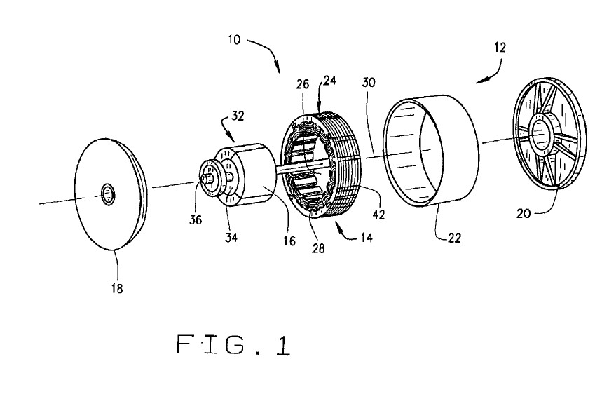

FIG. 1 is an exploded perspective view of a motor 10 including a housing 12, a stator assembly 14 and a rotor assembly 16. Housing 12 includes a pair of end shields 18, 20 and a shell 22. Stator assembly 14 mounts in housing 12 and includes a stator core 24 with a stator bore 26 extending therethrough. Stator core 24 provides support for a plurality of stator windings 28. In one embodiment, stator bore 26 is substantially cylindrical about a central axis 30. In one embodiment, motor 10 is an electronically commutated motor for use in heating, ventilation, and air conditioning (HVAC) systems such as a GE 39 Frame motor commercially available from General Electric Company, Schenectady, N.Y., and manufactured in Springfield, Mo.

Rotor assembly 16 is positioned within stator bore 26 and includes a rotor core 32, a rotor mounting assembly 34, and a rotor shaft 36. Rotor shaft 36 is substantially cylindrical and concentric about axis 30. Rotor mounting assembly 34 extends axially through rotor core 32 and rotor shaft 36 extends axially through rotor mounting assembly 34.

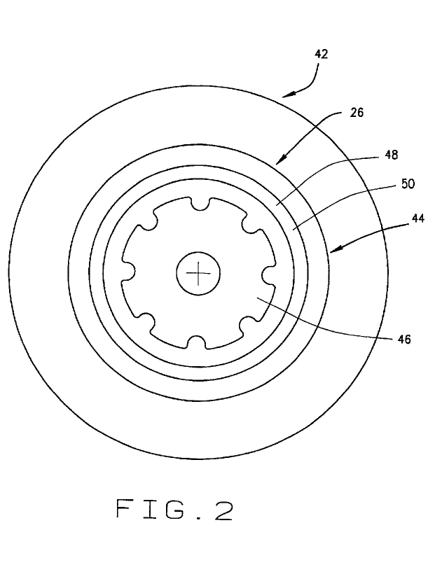

FIG. 2 is an enlarged top view of a punched laminate element 42. Stator core 24 is fabricated from multiple laminate elements 42. Specifically, stator bore 26 is formed by punching a center blank lamination 44 from each laminate element 42 and the subsequent interlocking of the laminate elements 42. As described below, an insert lamination 46, an outer ring lamination 48, and a spacer lamination 50 are formed by punching a center blank lamination 44.

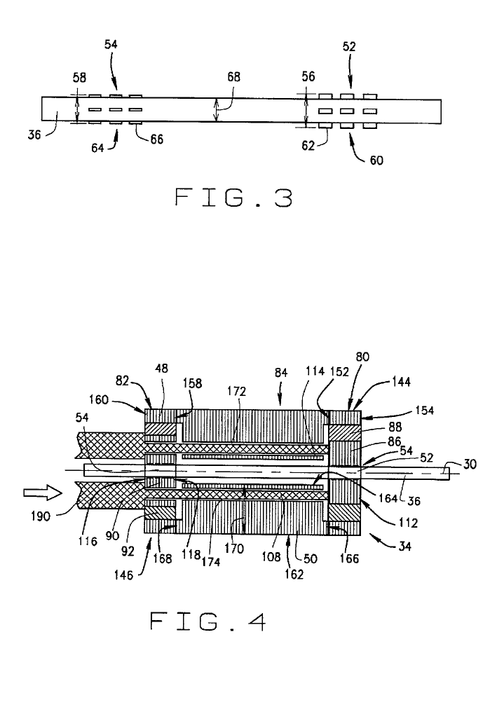

FIG. 3 is a side view of an exemplary embodiment of rotor shaft 36. As illustrated, rotor shaft 36 includes a first knurled portion 52 and a second knurled portion 54. First knurled portion 52 is knurled to facilitate a secure press fit relationship and has a first outside diameter 56. Second knurled portion 54 is also knurled and has a second outside diameter 58. In an exemplary embodiment first outside diameter 56 is larger than second outside diameter 58. In an exemplary embodiment a first knurled set 60 is formed on first knurled portion 52 and includes a spaced arrangement of a plurality of first knurls 62. A second knurled set 64 is formed on second knurled portion 54 and also includes a spaced arrangement of second knurls 66. In an exemplary embodiment shaft 36 includes a third outside diameter 68.

FIG. 4 is a cross-sectional view of an exemplary embodiment of laminated rotor mounting assembly 34. Rotor mounting assembly 34 includes a first resilient ring 80, a second resilient ring 82 and a laminated spacer 84. First resilient ring 80 includes a first inner metal insert 86 and a first resilient insert 88. Second resilient ring 82 includes a second inner metal insert 90 and a second resilient insert 92.

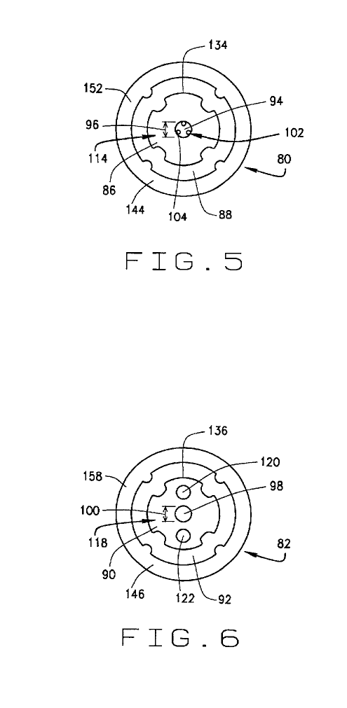

FIG. 5 is a side view of first resilient ring 80 of laminated rotor mounting assembly 34 of FIG. 4. FIG. 6 is a side view of second resilient ring 82. As shown in FIGS. 4, 5 and 6, resilient inserts 88, 92 circumferentially abut inner metal inserts 86, 90. First inner metal insert 86 includes a first central bore 94 with a first inner diameter 96. As illustrated in FIG. 6, second inner metal insert 90 includes a second central bore 98 with a second inner diameter 100. In an exemplary embodiment first inner diameter 96 is larger than second inner diameter 100. Each central bore 94, 98 receives rotor shaft 36. First central bore 94 is sized to pass over second knurled portion 54 and facilitate a secure press fit relationship between first inner metal insert 86 and first knurled portion 52. Second central bore 98 is sized to facilitate a secure press fit relationship between second inner metal insert 90 and second knurled portion 54.

In an alternative embodiment shown in FIG. 5, first central bore 94 includes a third knurled set 102 of spaced apart third knurls 104 complementary to second knurled set 64, arranged to pass axially between second knurls 66 of second knurled portion 54, while facilitating a secure press fit relationship between first inner metal insert 86 and first knurled portion 52. In an alternative embodiment (not shown), second central bore 98 also included a fourth knurled set (not shown) to facilitate a secure press fit between second inner metal insert 90 and second knurled portion 54.

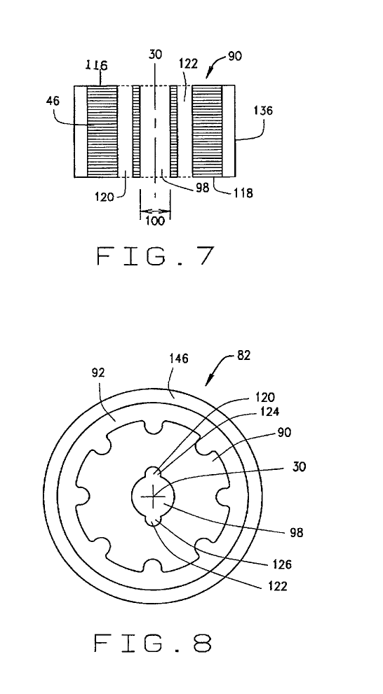

As shown in FIGS. 4 and 5 first inner metal insert 86 includes an external side 112 and an internal side 114. As shown in FIGS. 4 and 7 second inner metal insert 90 includes an external side 116 and an internal side 118. In an exemplary embodiment, shown in FIGS. 4 and 7, second inner metal insert 90 includes two apertures 120, 122 extending axially through the second inner metal insert 90 from the external side 116 to the internal side 118.

In an alternative embodiment, illustrated in FIG. 8, apertures 120, 122 each include an open boundary with central bore 98, forming a non-circular central bore having lobes 124, 126.

Inner metal insert 86, 90 each include an outer cylindrical edge 134, 136. In one embodiment, outer cylindrical edges 134, 136 are scalloped, as illustrated in FIGS. 5 and 6 to facilitate coupling between inner metal inserts 86, 90 and resilient inserts 88, 92. In one embodiment, as shown in FIGS. 2 and 7 for inner metal insert 90, each inner metal insert 86, 90 is fabricated from a plurality of insert laminations 46 punched from center blank laminations 44. Insert laminations 46 are interlocked to provide cost-effective and reliable inner metal inserts 86, 90.

In the exemplary embodiment each resilient ring 80, 82 further includes a laminated outer annular ring 144, 146 which circumferentially abut resilient inserts 88, 92. Each laminated outer annular ring 144, 146 is fabricated from a plurality of punched outer ring laminations 48, as shown in FIG. 2. In one embodiment, center blank laminations 44 are punched to fabricate outer ring laminations 48. Outer ring laminations 48 are interlocked to form specifically sized, laminated outer annular rings 144, 146.

As illustrated in FIGS. 4 and 5, first laminated outer annular ring 144 in first resilient ring 80 includes an interior radial face 152 and an external radial face 154. As illustrated in FIGS. 4 and 6, second laminated outer annular ring 146 in second resilient ring 82 includes an interior radial face 158 and an external radial face 160.

Laminated spacer 84 includes an outer cylindrical surface 162, an inner surface 164, a first radial side 166 and a second radial side 168, and has a thickness 170 between outer cylindrical surface 162 and inner surface 164. In one embodiment, outer cylindrical surface 162 receives magnets, as used in a brushless DC motor, wherein outer cylindrical surface 162 is sized to facilitate attachment of arc magnets. Inner surface 164 does not contact rotor shaft 36. Thickness 170 may be varied to optimize laminated spacer mass for noise reduction. In one embodiment, laminated spacer 84 includes a pair of axial openings 172, 174, positioned to align with apertures 120, 122. First radial side 166 of laminated spacer 84 attaches to interior radial face 152 of outer annular ring 144, and second radial side 168 attaches to interior radial face 158 of outer annular ring 146.

Laminated spacer 84 is fabricated using center blank laminations 44. In one embodiment, laminate element 42 is punched and laminated to produce stator bore 26 in stator core 24. Punched center blank laminations 44 are punched to form spacer laminations 50. Spacer laminations 50 are interlocking to form laminated spacer 84. In an alternative embodiment, center blank laminations 44 are sized and punched during the stator bore 26 punching. Spacer laminations 50 are interlocked by methods known in the art, such as adhesive bonding, mechanical pinning, interlocking features or welding.

Resilient inserts 88, 92 are fabricated from a suitable rubber material or elastomer. As is known in the art, an insert molding, transfer molding or press process is used to install resilient inserts 88, 92 between inner metal inserts 86, 90 and outer annular rings 144, 146.

In constructing resilient mounting assembly 34, resilient rings 80, 82 and spacer 84 are fabricated from resilient inserts 88, 92 and center blank laminations 44 produced from a stator laminate bore punch process. Inner metal inserts 86, 90, outer annular rings 144, 146, and laminated spacer 84 are assembled from insert laminations 46, outer ring laminations 48, and spacer laminations 50 punched from center blank laminations 44. In one embodiment, shown in FIG. 2, dimensions of insert laminations 46, outer ring laminations 48, and spacer laminations 50 are formed during the initial stator laminate bore punch process. In an alternate embodiment, center blank laminations 44 are punched separately to the desired dimensions. Insert laminations 46, outer ring laminations 48, and spacer laminations 50 are then interlocked by methods known in the art such as adhesive bonding, mechanical pinning, interlocking features or welding to fabricate inner metal inserts 86, 90, outer annular rings 144, 146, and laminated spacer 84. The interlocked laminates may be machined prior to assembly of resilient mounting assembly 34.

The operator attaches resilient rings 80, 82 to spacer 84. In one embodiment the operator secures arc magnets to resilient rings 80, 82 and spacer 84, completing rotor assembly 16 with the exception of installation of rotor shaft 36. This allows for reduced handling of rotor shaft 36 and more flexible assembly procedures. The operator inserts rotor shaft 36 in the resilient mounting assembly 34. First resilient ring 80 passes over second knurled portion 54 and shaft 36 until it abuts first knurled portion 52. Second resilient ring 82 will abut second knurled portion 54. The operator inserts a pair of press pins 190, shown in FIG. 4, each including a stepped portion 192, through apertures 120, 122 in the second resilient ring 82 and into contact with internal side 114 of first resilient ring 80. Stepped portions 192 are in contact with external side 11 6 of second resilient ring 82. In another embodiment, multiple pairs of press pins (not shown) are used to press both resilient rings 80, 82. The operator operates the press (not shown) to simultaneously press both resilient rings 80, 82 into a press fit relationship with the rotor shaft knurled portions 52, 54 from one axial direction, in one operation, reducing manufacturing cost.

During operation, as motor 10 is energized, rotor core 32 (shown in FIG. 1) rotates to align with a magnetic field generated within stator assembly 14 (shown in FIG. 1). As torque ripple occurs in rotor core 32, resilient inserts 88, 92 of rotor mounting assembly 34 damp vibrations and non-uniform torque transmitted to rotor shaft 36. As a result, motor 10 operation is quiet and smooth. More complex and expensive damping systems may be eliminated. Laminated outer annular rings 144, 146 and laminated spacer 84 contribute to a reliable and cost-effective assembly between rotor shaft 36 and rotor core 32.

While the invention has been described in terms of various specific embodiments, those skilled in the art will recognize that the invention can be practiced with modification within the spirit and scope of the claims.

1. A method of fabricating a rotor mounting assembly for vibration damping, said method comprising the steps of:
coupling a first resilient ring to a spacer;
coupling a second resilient ring to the spacer; and
simultaneously pressing the first resilient ring and the second resilient ring onto a rotor shaft.

2. A method in accordance with claim 1wherein said step of coupling a first resilient ring further comprises the step of interlocking the spacer to the first resilient ring.

3. A method in accordance with claim 1 wherein said step of coupling a second resilient ring further comprises the step of interlocking the spacer to the second resilient ring.

4. A method in accordance with claim 1 wherein said step of coupling a first resilient ring and said step of coupling a second resilient ring are completed simultaneously.

5. A method in accordance with claim 1 wherein said steps of coupling a first resilient ring and coupling a second resilient are completed prior to said step of simultaneously pressing.

6. A method in accordance with claim 1 wherein said method further includes attaching a plurality of magnets to the spacer prior to said step of simultaneously pressing.

7. A method in accordance with claim 1 wherein said step of simultaneously pressing includes inserting at least one press pin through the second resilient ring to press directly on the first resilient ring and the second resilient ring simultaneously.

8. A method in accordance with claim 1, the rotor shaft including an axis, wherein said step of simultaneously pressing includes pressing the first resilient ring and the second resilient ring simultaneously from the same axial direction.

9. A method in accordance with claim 1 wherein said step of simultaneously pressing includes inserting the rotor shaft through the first resilient ring and the second resilient ring wherein the rotor shaft includes at least a first outside diameter and a second outside diameter, the first resilient ring includes a first central bore having a first inside diameter and the second resilient ring includes a second central bore having a second inside diameter such that the first inside diameter passes though the second outside diameter, while the first inside diameter cooperates with the first outside diameter to ensure a secure press fit relationship between the first resilient ring and the rotor shaft and the second inside diameter cooperates with the second outside diameter to ensure a secure press fit relationship between the second resilient ring and the rotor shaft.

10. A method of fabricating a rotor mounting assembly for vibration damping, said method comprising the steps of:
coupling a first resilient ring to a spacer by interlocking a spacer to the first resilient ring;
simultaneously coupling a second resilient ring to the spacer by interlocking the spacer to the second resilient ring;
attaching a plurality of magnets to the spacer; and
simultaneously pressing the first resilient ring and the second resilient ring onto a rotor shaft including an axis, subsequent to completing said steps of coupling, simultaneously coupling and attaching a plurality of magnets, said step of simultaneously pressing including inserting at least one press pin through the second resilient ring to press on the first resilient ring and the second resilient ring simultaneously and pressing the first resilient ring and the second resilient ring from one axial direction.

11. A method of fabricating a resilient ring for a rotor mounting assembly, said method comprising the steps of:
punching a plurality of center blanks from a plurality of stator laminates;
punching a plurality of outer ring laminates from the plurality of center blanks, each outer ring laminate having a central bore;
laminating the outer ring laminates to form an annular ring having a center axis within the central bore;
punching a plurality of insert laminations from the plurality of center blanks, the insert laminations each including at least one aperture and a central bore;
laminating the insert laminations to form an inner metal insert having a central axis within the central bore;
positioning the inner metal insert coaxially within the annular ring; and
inserting a resilient insert between the annular ring and the inner metal insert, such that the resilient insert abuts and frictionally engages both the annular ring and the inner metal insert.

12. A method in accordance with claim 11 wherein the at least one aperture includes an open boundary with the central bore.

13. A method in accordance with claim 12 wherein said step of inserting a resilient insert includes the process of insert molding the resilient insert between the annular ring and the inner metal insert.

14. A method in accordance with claim 12 wherein said step of inserting a resilient insert includes pressing the resilient insert into the annular ring.

15. A rotor mounting assembly for an electric motor having a rotor core and a rotor shaft extending through the rotor core, said assembly comprising:
a spacer having a distal end and a proximate end;
a first resilient ring attached to said distal end, said first resilient ring having an internal face; and
a second resilient ring attached to said proximate end, said second resilient ring having an internal side, an external side, and at least one aperture therethrough configured such that a press pin can press against said first resilient ring internal face, said rotor mounting assembly positioned on said rotor shaft.

16. A rotor mounting assembly in accordance with claim 15 wherein said first resilient ring, said second resilient ring, and said spacer form a cylinder.

17. A rotor mounting assembly in accordance with claim 15 wherein said spacer includes at least one aperture therethrough.

18. A rotor mounting assembly in accordance with claim 15 wherein each said first resilient ring and each said second resilient ring include an inner metal insert and a resilient insert.

19. A rotor mounting assembly in accordance with claim 18 wherein each said inner metal insert includes a periphery including a plurality of scallops.

20. A rotor mounting assembly in accordance with claim 18 wherein each said inner metal insert constructed from laminate.

21. A rotor mounting assembly in accordance with claim 18 wherein the at least one aperture extends through said inner metal insert of said second resilient ring.

22. A rotor mounting assembly in accordance with claim 18 wherein:
said rotor shaft comprises at least a first outside diameter portion and a second outside diameter portion;
said first resilient ring includes a first central bore having a first inside diameter; and
said second resilient ring includes a second central bore having a second inside diameter, said first inside diameter configured to pass over said second outside diameter portion and engage said first outside diameter portion to provide a secure press fit, said second inside diameter engaging said second outside diameter portion to provide a secure press fit.

23. A rotor mounting assembly in accordance with claim 22 wherein said rotor shaft first outside diameter portion and second outside diameter portion each comprise knurls.

24. A rotor mounting assembly in accordance with claim 18 wherein:
said rotor shaft comprises a first outside diameter portion and a second outside diameter portion, said first outside diameter portion comprising a first knurl set and second outside diameter portion comprising a second knurl set; and
said first resilient ring includes a first central bore comprising a first inside diameter, said first inside diameter comprising a third knurl set, said third knurl set able to pass through said second knurl set and engage said first knurl set to provide a secure press fit.

25. A rotor mounting assembly in accordance with claim 24 wherein:
said second resilient ring includes a second central bore having a second inside diameter, said second central bore comprising a fourth knurl set, said third knurl set able to pass through said second knurl set and engage said first knurl set to provide a secure press fit, said fourth knurl set engaging said second knurl set to provide a secure press fit.

26. A motor comprising:
a motor housing comprising a pair of end shields and a shell;
a stator assembly positioned within said motor housing and comprising a stator core and a stator bore extending there through, said stator core comprising a plurality of stator windings; and
a rotor assembly positioned within said stator bore, said rotor assembly comprising a rotor mounting assembly, a plurality of magnetic elements attached to said rotor mounting assembly, and a rotor shaft extending through said rotor mounting assembly and said end shield, said rotor mount assembly comprising a laminated spacer, a first resilient ring, and a second resilient ring, said spacer including a distal end and a proximate end, said first resilient ring attached to said distal end, said first resilient ring comprising an internal face and a central bore receiving said rotor shaft, and said second resilient ring attached to said proximate end, said second resilient ring comprising a second central bore receiving said rotor shaft, an internal side, an external side, and at least one aperture therethrough configured such that a press pin can press against said first resilient ring internal face.

27. A motor according to claim 26 wherein said first resilient ring, said second resilient ring, and said spacer form a cylinder.

28. A motor according to claim 26 wherein said spacer includes at least one aperture therethrough.

29. A motor according to claim 26 wherein each said first resilient ring and each said second resilient ring include an inner metal insert and a resilient insert.

30. A motor according to claim 29 wherein each said inner metal insert includes a periphery including a plurality of scallops.

31. A motor according to claim 29 wherein each said inner metal insert constructed from laminate.

32. A motor according to claim 29 wherein the at least one aperture extends through said inner metal insert of said second resilient ring.

33. A motor according to claim 26 wherein:
said rotor shaft comprises a first outside diameter portion and a second outside diameter portion;
said first resilient ring said first central bore having a first inside diameter; and
said second resilient ring said second central bore having a second inside diameter, said first inside diameter able to pass over said second outside diameter portion and engaging said first outside diameter portion to provide a secure press fit, said second inside diameter engaging said second outside diameter portion to provide a secure press fit.

34. A motor according to claim 26 wherein:
said rotor shaft comprises a first outside diameter portion and a second outside diameter portion, said first outside diameter portion comprising a first knurl set and second outside diameter portion comprising a second knurl set;
said first resilient ring includes a first central bore having a first inside diameter said first inside diameter comprising a third knurl set; and
said second resilient ring includes a second central bore having a second inside diameter, said second central bore comprising a fourth knurl set, said third knurl set able to pass through said second knurl set and engaging said first knurl set to provide a secure press fit, said fourth knurl set engaging said second knurl set to provide a secure press fit.
